(19) United States
(12) Patent Application Publication
(10) Pub. No.: US 2003/0031401 A1
(43) Pub. Date: Feb. 13, 2003

(54) Apparatus and method to increase the extinction ratio in a Mach-Zehnder interferometer

(75) Inventor: William K. Burns, Alexandria, VA (US)

Correspondence Address: MORGAN LEWIS & BOCKIUS LLP, 1111 PENNSYLVANIA AVENUE NW, WASHINGTON, DC, 20004, US

(73) Assignee: Codeon Corporation

(21) Appl. No.: 09/923,315

(22) Filed: Aug. 8, 2001

(51) Int. Cl. G02B 6/26; G02B 6/125

(52) U.S. Cl. 385/15; 385/14

(57) ABSTRACT

A Mach-Zehnder Interferometer having a waveguide including an input portion for receiving an optical signal and having a first channel width, a first splitter for separating the optical signal into at least first and second paths, a first arm for the first path and having a second channel width that supports a single transverse optical mode, a second arm for the second path and having a third channel width that supports a single transverse optical mode, a second splitter portion for combining optical signals of the at least first and second paths, an output portion for transmitting a resultant combination of optical signals from the second splitter and having a fourth channel width, and wherein the second channel width is larger than the fourth channel width.

### BACKGROUND OF THE INVENTION

1. Field of the Invention

The present invention relates to a Mach-Zehnder Interferometer optical modulator device and, more particularly, to a Mach-Zehnder Interferometer with an increased extinction ratio or an interaction region with an increased length.

2. Background of the Related Art

Mach-Zehnder Interferometers (MZI's) used as optical modulators are of great interest for high data rate fiber optic communication systems. A great deal of research has been carried out to develop MZI's since their introduction in the mid 1970's. The practicality of Ti-diffused LiNb0₃ waveguide systems has allowed the introduction of MZI's into communication systems.

Parameters of interest for a MZI, which are indicative of the device's performance, include modulation efficiency, drive voltage, optical insertion losses due to fiber coupling efficiency, optical wavelength operating range and extinction ratio. Modulation efficiency can be achieved by microwave design and optical-microwave phase velocity matching techniques. Drive voltages can be lowered and/or made more effective by maximizing electro-optic overlap in the interaction region of the MZI. Optical insertion losses may be improved by advances in waveguide technology that enable mode matching of the optical field at the waveguide-fiber interface. Broad optical wavelength operating ranges can be achieved by controlling waveguide dispersions within the MZI. The extinction ratio is a measure of how well an optical device is turned off, usually given as a ratio in decibels (dB) between the output of a signal when the device is turned on and the output of a leakage signal when the device is turned off.

The extinction ratio directly affects the “eye diagram,” which is a display on an oscilloscope of modulated known “1” and “0” signals to determine if the signals are being properly modulated by the device. An “open” eye shows a good signal with distinct differences between 1s and 0s. A “closed” or “fuzzy” eye means that some 0s could be seen as is and vice versa. Therefore, it is important that a high extinction ratio is achieved to lower bit-error-rates in optical communication systems.

FIG. 1 illustrates a plan view of a MZI of the related art. As shown in FIG. 1, a waveguide 1 is formed in an electro-optic substrate 2. The waveguide is comprised of an input portion 3, a first splitter portion 4, a first arm 5, a second arm 6, a second splitter portion 7 and an output portion 8. The input portion 3 is connected to the first splitter portion 4, which separates into a first branch 4a and a second branch 4b. The dashed line AA′ in FIG. 1 indicates where the input portion 3 ends and the first splitter portion 4 begins. The dashed line AA′ is where the sides of the input portion 3 are no longer in parallel or where the sides of the first splitter portion 3 are no longer curving. The first arm 5 is connected to the first branch 4a of the first splitter portion 3 and the second arm 6 is connected to the second branch 4b of the first splitter portion 4. The dashed lines BB′ and CC′ in FIG. 1 indicate where the first splitter portion 3 ends, and where the first arm 5 and second arm 6 begin, respectively. The dashed lines BB′ and CC′ are where the sides of the first arm 5 and second arm 6 are no longer in parallel, or where the sides of the first splitter portion 3 are no longer curving. A first branch 7a of the second splitter portion 7 is connected to the first arm 5 and a second branch 7b of the second splitter portion 7 is connected to the second arm 6. The dashed lines DD′ and EE′ in FIG. 1 indicate where the second splitter portion 7 ends, and where the first arm 5 and second arm 6 end, respectively. The dashed lines DD′ and EE′ are where the sides of the first arm 5 and second arm 6 are no longer in parallel, or where the sides of the second splitter portion 7 are no longer curving. The branches of the second splitter portion 7 come together and the output portion 8 is connected to the second splitter portion 7. The dashed line FF′ in FIG. 1 indicates where the output portion 8 begins and the second splitter portion 7 ends. The dashed line FF′ is where the sides of the output portion 8 are no longer in parallel or where the sides of the second splitter portion 7 are no longer curving. Optical fiber lines (not shown) are respectively attached to the input portion 3 and the output portion 8 of the waveguide of the related art MZI.

Typically, as shown in FIG. 1, the channel widths W1 of the waveguide's arms 5 and 6, and the channel widths W2 of the input/output portions 3 and 8 are adjusted such that the channel widths of the arms support a single transverse optical mode over a predetermined optical wavelength operating range. All of the channel widths W1 of the waveguide's arms 5, 6 and the channel widths W2 of the input/output portions 3, 8 are the same (i.e., W1=W2). Both the input portion 1 and the output portion 8 of the waveguide in the related art MZI have the same length L1 measured from an end of the waveguide to a splitter for symmetry in fabrication of the device. For purposes of subsequent explanation of the invention, the MZI is bifurcated into an input side where the input signal is received and an output side where the output signal emanates.

Operation of the MZI is shown FIGS. 2a and 2b. Specifically, FIG. 2a illustrates the operation of a MZI in an on-state (i.e., Δφ=0) and FIG. 2b illustrates that operation of a MZI in an off-state (i.e., Δφ=Π). Both of FIGS. 2a and 2b show how a single transverse optical mode is input to the input portion 3 of the waveguide on the input side of the device. Furthermore, FIGS. 2a and 2b show that the single transverse optical mode is divided into equal powers by the splitter portion 4, which separates the optical mode into the arms 5 and 6 of the interferometer.

As shown in FIG. 2a, when no differential phase shift Δφ is applied to the optical modes in the separated paths (i.e., Δφ=0), the second splitter 7 combines the separated optical modes and outputs a first order transverse optical mode. Consequently, an optical output fiber (not shown) connected to the output portion 8 picks up this first order transverse optical mode.

As shown in FIG. 2b, when a differential phase shift Δφ of modulus ii (i.e., Δφ=Π) is applied to the optical modes in the separated paths by voltages applied through electrodes (not shown) in the vicinity of the separated arms 5 and 6, the second splitter 7 combines the separated optical modes to form a second order transverse mode. Since the output portion 8 should only support a first order transverse optical mode, the second order transverse optical mode should be cut-off and radiate into the substrate. Therefore, the second order transverse optical mode should neither be outputted nor transmitted to an optical output fiber (not shown) connected to the output portion 8. The efficiency with which the second order transverse optical mode is radiated into the substrate and not into an optical output fiber is an important factor affecting the extinction ratio of an MZI.

### SUMMARY OF THE INVENTION

Accordingly, the present invention is directed to a Mach-Zehnder Interferometer (MZI) that substantially obviates one or more of the problems due to limitations and disadvantages of the related art.

One aspect of the invention is a Mach-Zehnder Interferometer with an improved extinction ratio for the input and output portions having a predetermined length.

Another aspect of the invention is a Mach-Zehnder Interferometer in which the overall device length with respect to desired extinction ratio is minimized.

Also, another aspect of the invention is a Mach-Zehnder Interferometer in which a substrate size can be optimized with increased drive voltage efficiencies while maintaining a predetermined extinction ratio.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a plan view of a related art Mach-Zehnder Interferometer;

FIG. 2a illustrates the operation of a Mach-Zehnder Interferometer in an on-state;

FIG. 2b illustrates the operation of a Mach-Zehnder Interferometer in an off-state;

FIG. 3a is a plan view of the output side of a Mach-Zehnder Interferometer;

FIG. 3b is a cross-sectional view of the output side of a Mach-Zehnder Interferometer;

FIG. 4a is a mode dispersion diagram for the first two transverse optical modes in the output side of a Mach-Zehnder Interferometer;

FIG. 4b shows the cutoff angle a in an electro-optic substrate of the Mach-Zehnder Interferometer as function of the channel widths of the output portion illustrated in FIG. 4a;

FIG. 5 is a plan view of the output side of an exemplary Mach-Zehnder Interferometer according to the first embodiment of the present invention;

FIG. 6 is a plan view of the output side of an exemplary Mach-Zehnder Interferometer according to the second embodiment of the present invention;

FIG. 7 is a plan view of the output side of an exemplary Mach-Zehnder Interferometer according to the third embodiment of the present invention; and

FIG. 8 is a graph showing exemplary improvements in the extinction ratio of a Mach-Zehnder Interferometer in accordance with the present invention;

FIGS. 9a, 9b and 9c respectively show the plan views of fourth, fifth and sixth exemplary embodiments in accordance with the present invention; and

FIGS. 10a and 10b are illustrative of other exemplary types of Mach-Zehnder Interferometers in which the extinction ratio can be improved in accordance with the present invention.

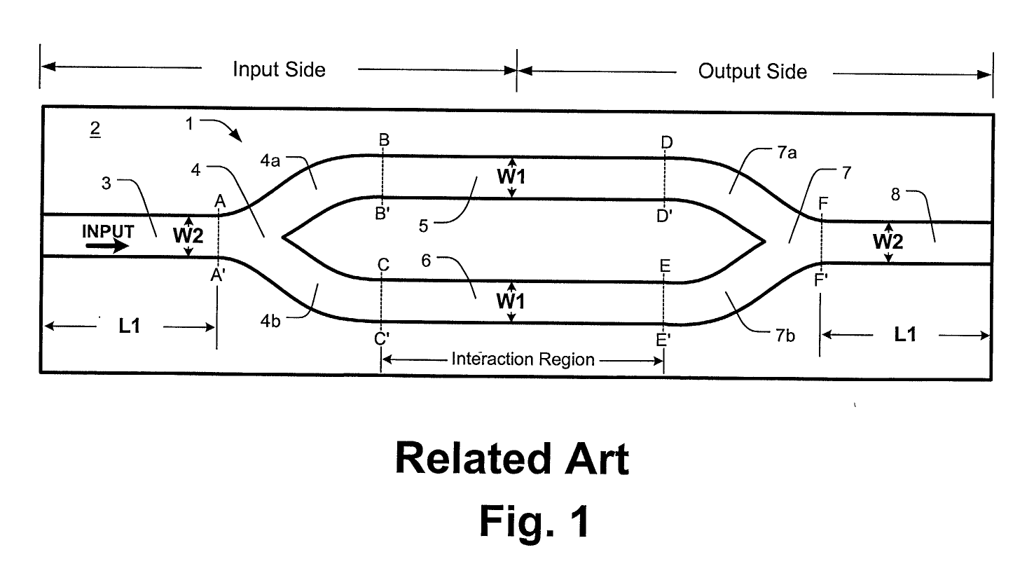

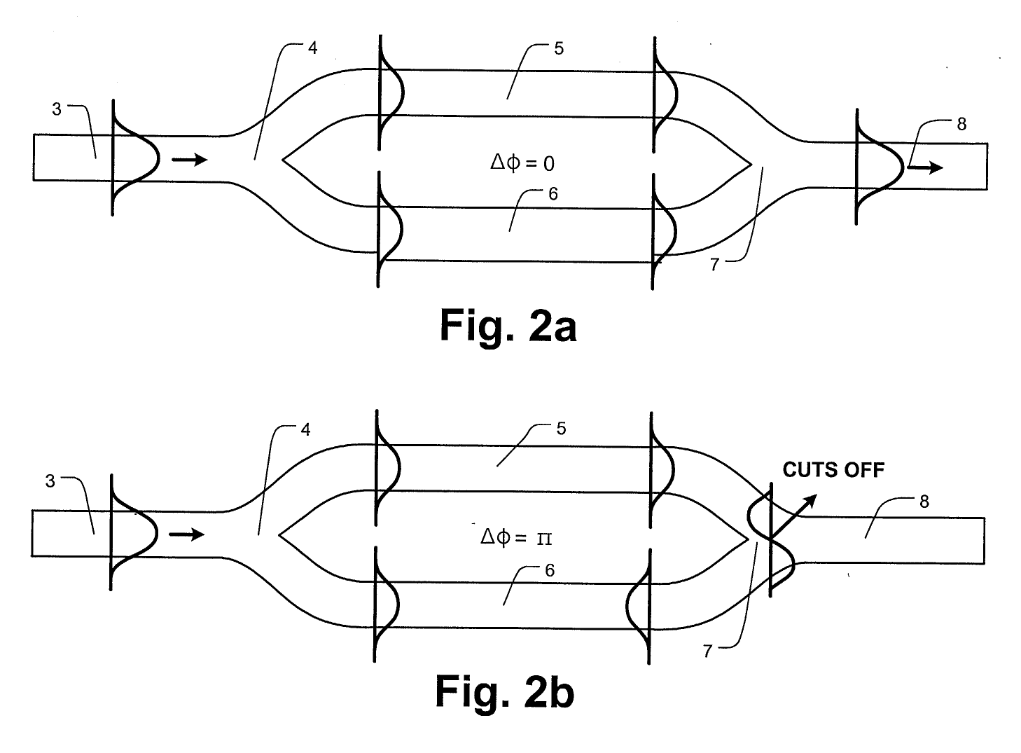

### DETAILED DESCRIPTION OF THE PREFERRED EMBODIMENTS

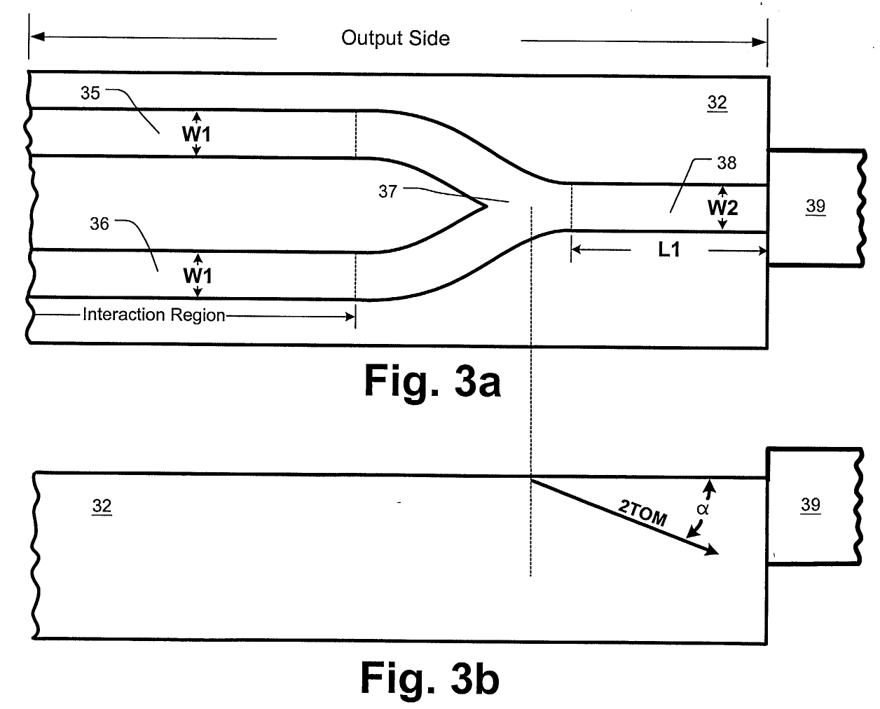

FIGS. 3a and 3b respectively show plan and cross-sectional views of the output side of a MZI. Particularly, FIG. 3a shows an electro-optic substrate 32 of a waveguide having, a first arm 35, a second arm 36, a second splitter portion 37 and an output portion 38. FIG. 3a further shows an optical output fiber 39 connected to the output portion 38. FIG. 3b illustrates that the cutoff angle α is measured between the cut-off second order transverse optical mode (2TOM) radiating into the substrate 32 and the substrate surface. Together, FIGS. 3a and 3b illustrate that both the cutoff angle α and the length L1 of the output portion 38 must be sufficiently large to prevent any of the cut-off second order transverse optical mode that is radiating into the substrate from being transmitted into the optical output fiber 39.

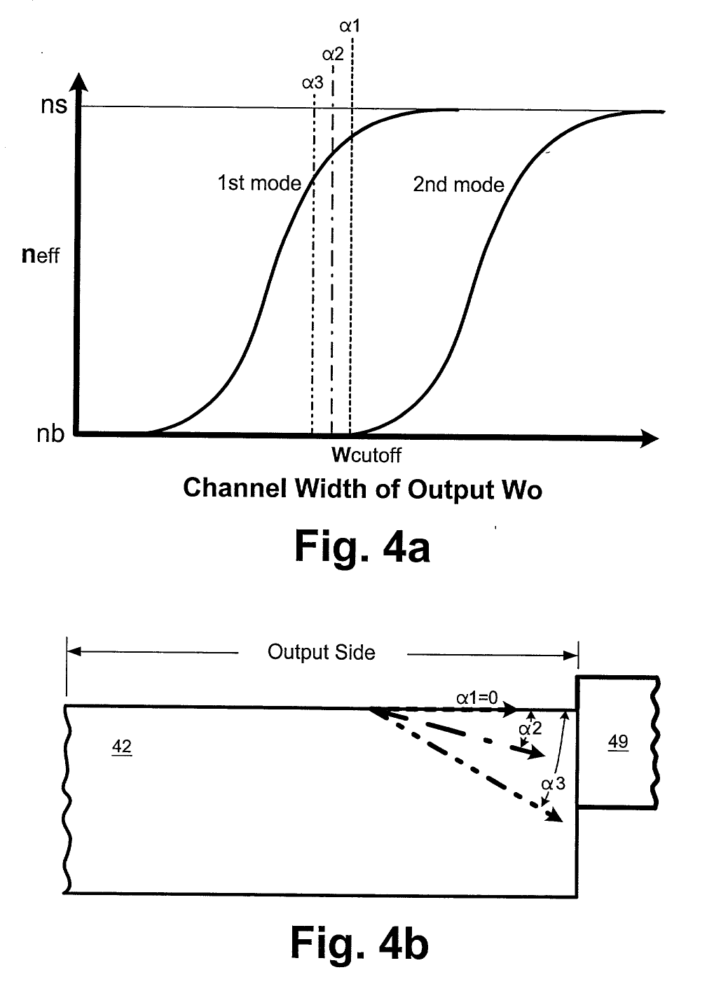

FIG. 4a is a mode dispersion diagram for the first two transverse optical modes in the output portion of a MZI. This diagram shows the mode effective index, nff, for each mode as a function of the channel width W2 of the output portion. The substrate has a bulk index of refraction nb and a surface index of refraction ns. The surface index of refraction ns is a result of the waveguide in the surface of the substrate. FIG. 4b is a cross-sectional view of an electro-optic substrate 42 of a MZI connected to an optical output fiber 49 showing the cutoff angle α as a function of the channel widths of the output portion illustrated in FIG. 4a. As shown in FIGS. 4a and 4b, when the second order mode is just at cutoff (W=W_{cutoff}) for the substrate, the cutoff angle is zero (α=0) degrees as represented by horizontal arrow. As W is decreased below W_{cutoff}, the cutoff angle α increases and the second order transverse optical mode radiates into the substrate at a larger angle.

Applicant has learned that when designing a MZI, the length L of the input and output portions can be shortened so as to increase the interaction length of the MZI (i.e., the length of the arms 35 and 36). For example, the length L of an output portion would be about 3-8mm in a Ti:LiNbO₃ waveguide at 1.55 μm operating wavelength. A larger cutoff angle α allows for a shorter output portion while still preventing the optical output fiber from directly receiving the cut-off second order transverse optical mode. Otherwise, the extinction ratio would be degraded by the optical output fiber receiving the cut-off second order transverse optical mode.

An output portion with a narrower channel width Wo than the channel width Wa of the arms can maintain an extinction ratio while using a shorter output portion length, improve the extinction ratio for a predetermined output portion length, or improve the extinction ratio and enable the use of a shorter output portion length. In the interaction region of a MZI, between the splitters, drive voltage may be improved with tight optical confinement by keeping the channel width W of the arms large and close to their second order transverse optical mode cutoff Wcutoff value for the waveguide. Both of these constraints can be satisfied by using two different channel widths in the waveguide of the interferometer, a wider one Wa in the interaction region (i.e. the arms 5 and 6), and a narrower one Wo in the output channel. Furthermore, it is also useful to use a narrower channel in the input portion of the MZI because it minimizes the possibility of input coupling into the second order transverse optical mode of the input side of the device, which could also degrade the extinction ratio. A designer may choose to apply the present invention to one of or both the input and output sides of a MZI. In addition, a designer of optical modulators may take the extra length gained from the input and output portions, and use the extra length in the interaction region. Increasing the length of the interaction region of a MZI increase the drive voltage efficiency of electrodes overlying the arms of a MZI. Therefore, the present invention can increase the extinction ratio, increase drive voltage efficiency or increase both the extinction ratio and the drive voltage efficiency.

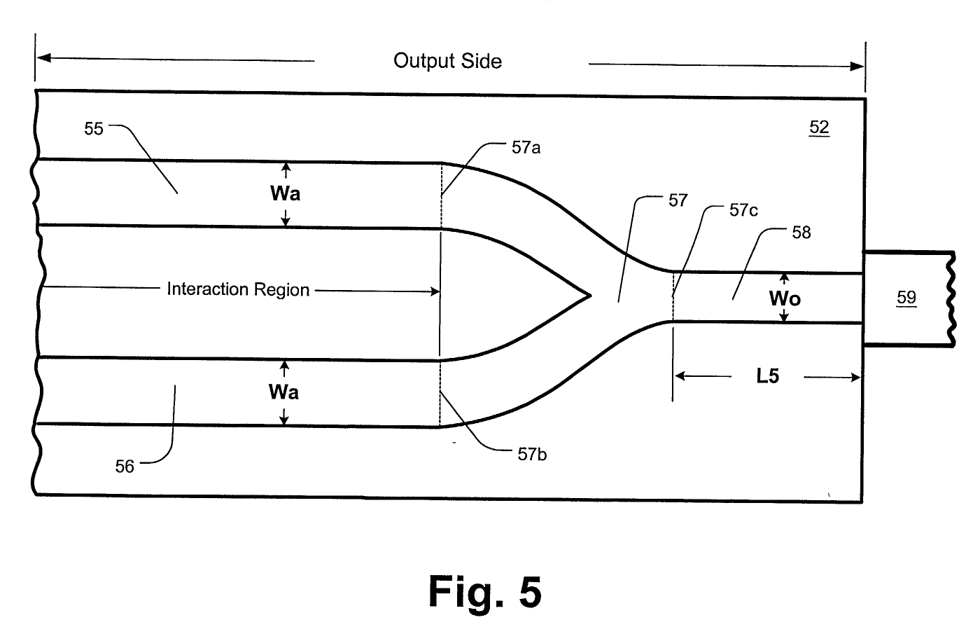

FIG. 5 shows a plan view of the output side of an exemplary MZI in accordance with a first embodiment of the present invention. FIG. 5 shows an electro-optic substrate 52 with a waveguide including, a first arm 55, a second arm 56, a second splitter portion 57, an output portion 58 and an optical output fiber 59. The channel widths Wa of the waveguide's arms 55 and 56 are adjusted such that the channels of the arms support or only support a single transverse optical mode over a predetermined optical wavelength operating range. As shown in FIG. 5, the channel width change between the width Wa of the channels in arms 55 and 56, and the width Wo of the channel of the output portion 58 is obtained through reduction of the channel widths in the second splitter 57.

The arm ends 57a and 57b of the second splitter 57 have a channel width Wa and the output portion end 57c of the second splitter 57 has a channel width Wo, which is smaller than Wa. The output portion 58 has a constant channel width Wo and is connected to an optical output fiber 59. The length L5 shown in FIG. 5, for example, can be about 3 to 8 millimeters. Exemplary values of the channel width Wo and the channel width Wa for a 1.55 μm wavelength are 4 to 8 μm and 6 to 10 μm, respectively.

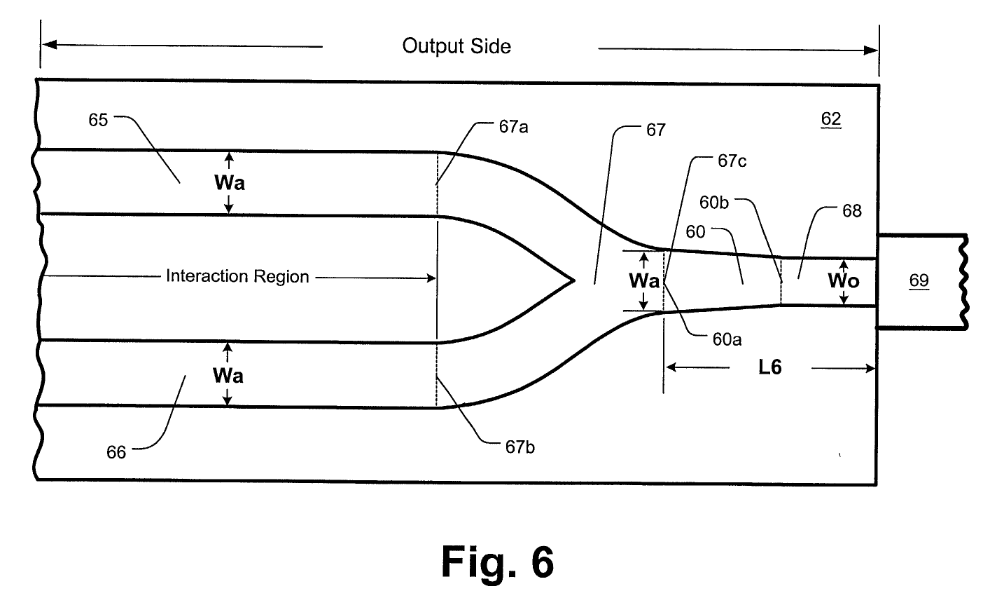

FIG. 6 shows a plan view of the output side of an exemplary MZI in accordance with a second embodiment of the present invention. FIG. 6 shows an electro-optic substrate 62 with a waveguide including a first arm 65, a second arm 66, a second splitter portion 67, a tapered output section 60, an output portion 68 and an optical output fiber 69. The channel widths Wa of the waveguide's arms 65 and 66 are adjusted such that the channels of the arms support or only support a single transverse optical mode over a predetermined optical wavelength operating range. As shown in FIG. 6, the channel width change between the width Wa of the channels in arms 65 and 66, and channel width Wo of the output portion 68 is obtained through a width reduction by the tapered section 60 having linear sides.

The arm ends 67a and 67b of the second splitter 67 have a channel width Wa and the tapered section end 67c of the second splitter 67 also has a channel width Wa. The tapered output section 60 has a first end 60a having a channel width Wa connected to the second splitter 67 and a second end 60b connected to the output portion 68 having a channel width Wo, which is smaller than the channel width Wa of the arms 65, 66. Although a channel width Wa is indicated above for the first end 60a of the tapered output section, the first end 60 a may have an intermediate channel width between Wa and Wo can be used. In such a case, the tapered section end 67c of the second splitter 67 would also have the same intermediate channel width between Wa and Wo. The output portion 68 has a constant channel width of Wo. The other end of the output portion 68 is connected to an optical output fiber 69. The length L6 shown in FIG. 6, for example, can be about 3 to 8 millimeters. Exemplary values of the channel width Wo and the channel width Wa for a 1.55 μm wavelength are 4 to 8 μm and 6 to 10 μm, respectively.

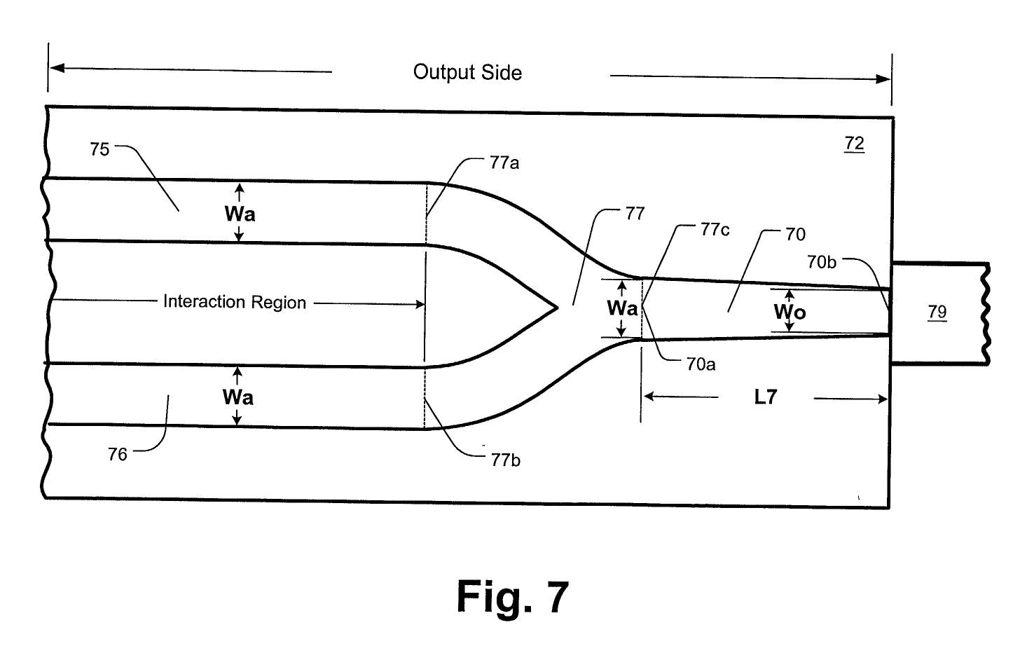

FIG. 7 shows a plan view of the output side of an exemplary MZI in accordance with a third embodiment of the present invention. FIG. 7 shows an electro-optic substrate 72 with a waveguide including, a first arm 75, a second arm 76, a second splitter portion 77, a tapered output portion 70 and an optical output fiber 79. The channel widths Wa of the waveguide's arms 75 and 76 are adjusted such that the channels of the arms support or only support a single transverse optical mode over a predetermined optical wavelength operating range. As shown in FIG. 7, the channel width change between the width Wa of the channels in arms 75 and 76, and channel width Wo at the end 70b of the tapered output portion 70 is obtained through reduction in the tapered output portion 70 having linear sides.

The arm ends 77a and 77b of the second splitter 77 have a channel width Wa and the output portion end 77c of the second splitter 77 has the same channel width Wa. The tapered output section 70 has first end 70a having a width Wa connected to the second splitter 77 and a second end 70b having a width Wo, which is smaller than Wa. Although a channel width Wa is indicated above for the first end 70a of the tapered output portion, an intermediate channel width between Wa and Wo can be used. In this case, the tapered output portion end 77c of the second splitter 77 would also have the same intermediate channel width between Wa and Wo. The second end 70b of the tapered output portion 70 is connected to an optical output fiber 79. The length L7 shown in FIG. 7, for example, can be about 3 to 8 mm. Exemplary values of the channel width Wo and the channel width Wa for a 1.55 μm wavelength are 4 to 8 μm and 6 to 10 μm, respectively.

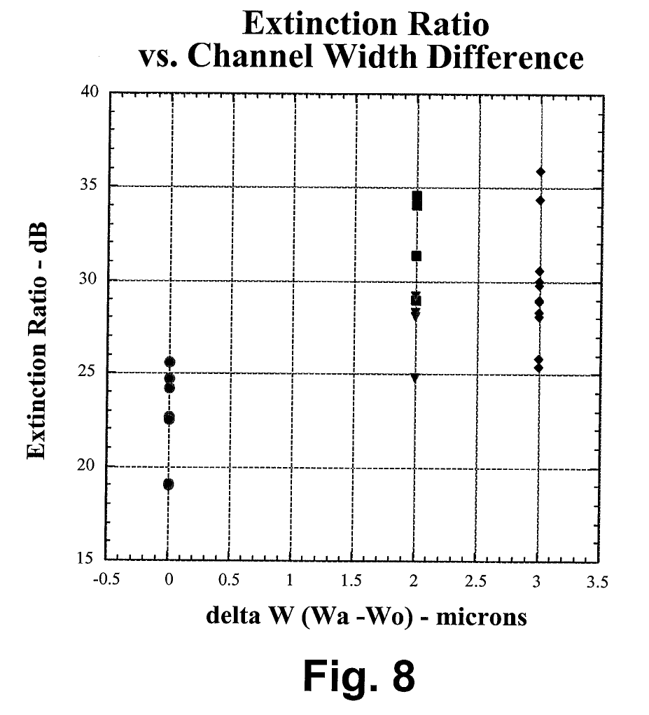

Exemplary improvements in the extinction ratio are shown in FIG. 8, where an extinction ratio for a variety of MZI's is plotted as a function of the change in channel width, Wa-Wo, as described above. For example, the extinction ratio is seen to be improved from a range of 20-25 dB to a range of 25-35 dB when the output channel width is reduced 2-3 microns from the usual single mode width close to the second mode cutoff. This data was taken with Ti:LiNbO₃ channels with (unreduced) widths Wa of 8 to 9 μm at 1.55 μm wavelength. All devices had the same output length of approximately 6 millimeters that is measured from the second splitter to an end of the output where an optical fiber can be connected. In the alternative, as discussed previously, the length of the output portion could be reduced below 6 mm without extinction ratio loss.

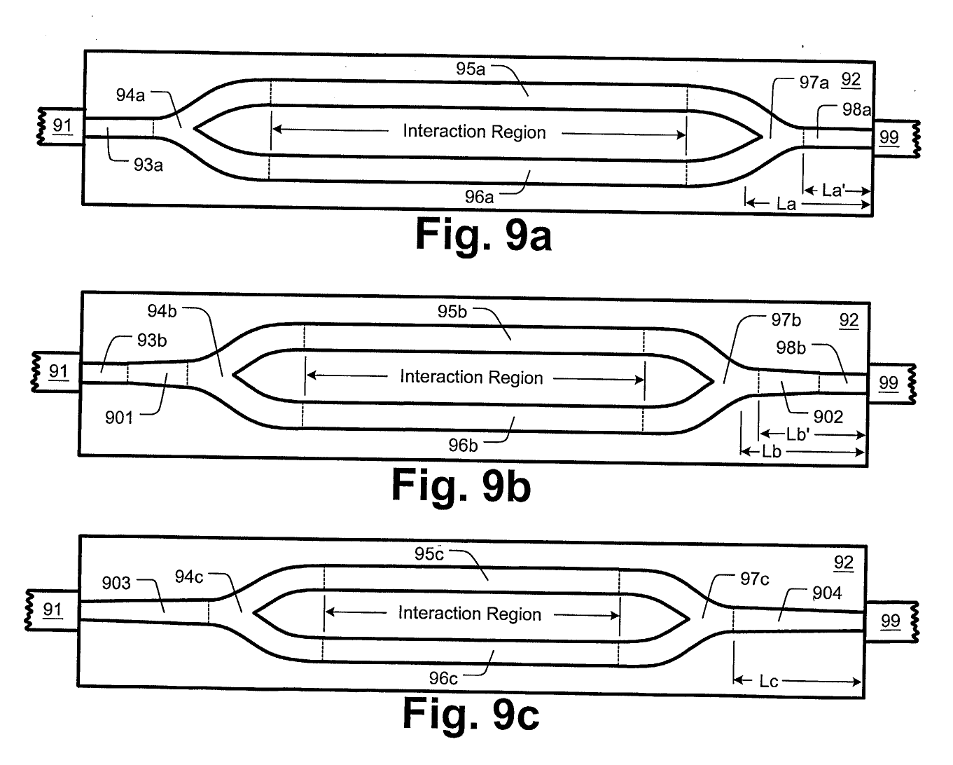

FIG. 9a is a plan view of an exemplary MZI in accordance with a fourth embodiment of the present invention. FIG. 9a shows an electro-optic substrate 92 with a waveguide having an input portion 93a, a first splitter 94a, a first arm 95a, a second arm 96a, a second splitter portion 97a and an output portion 98a. FIG. 9a further shows an optical output fiber 99 connected to the output portion 98a and an optical input fiber 91 connected to the input portion 93a. The drive voltage efficiency is increased by the arms 95a, 96a having longer lengths as a result of the output portion 98a and the input portion 93a being designed to have a shorter length La′ instead of a length La, as shown in FIG. 9a. In addition, the extinction ratio of a device having an output portion length La is maintained.

FIG. 9b is a plan view of an exemplary MZI in accordance with a fifth embodiment of the present invention. FIG. 9b shows an electro-optic substrate 92 with a waveguide having an input portion 93b, a tapered input section 901, a first splitter 94b, a first arm 95b, a second arm 96b, a second splitter portion 97b, a tapered output section 902 and an output portion 98b. FIG. 9b further shows an optical output fiber 99 connected to the output portion 98b and an optical input fiber 91 connected to the input portion 93b. The drive voltage efficiency is increased by the arms 95a, 96a having longer lengths as a result of the output portion 98a and the input portion 93a being designed to have a shorter length Lb′ instead of a length Lb, as shown in FIG. 9b. In addition, the extinction ratio is improved.

FIG. 9c is a plan view of an exemplary MZI in accordance with a sixth embodiment of the present invention. FIG. 9c shows an electro-optic substrate 92 with a waveguide having a tapered input portion 903, a first splitter 94c, a first arm 95c, a second arm 96c, a second splitter portion 97c and a tapered output portion 904. FIG. 9c further shows an optical output fiber 99 connected to the tapered output portion 904 and an optical input fiber 91 connected to the tapered input portion 903. The extinction ratio is improved compared to other related art MZI's having input and output portions with a length Lc, as shown in FIG. 9c. In the alternative, the overall device length (i.e., length of the substrate) could be shorter at the expense of the improvement in the extinction ratio.

Generally, the transition length, as indicated in FIGS. 5, 6 and 7, over which a channel width is changed, either in a splitter, tapered section or tapered output portion, should be sufficiently long so that it is adiabatic in the sense that mode conversion to unwanted radiation modes is minimized. This generally would require transition lengths on the order of about 1 millimeter or more.

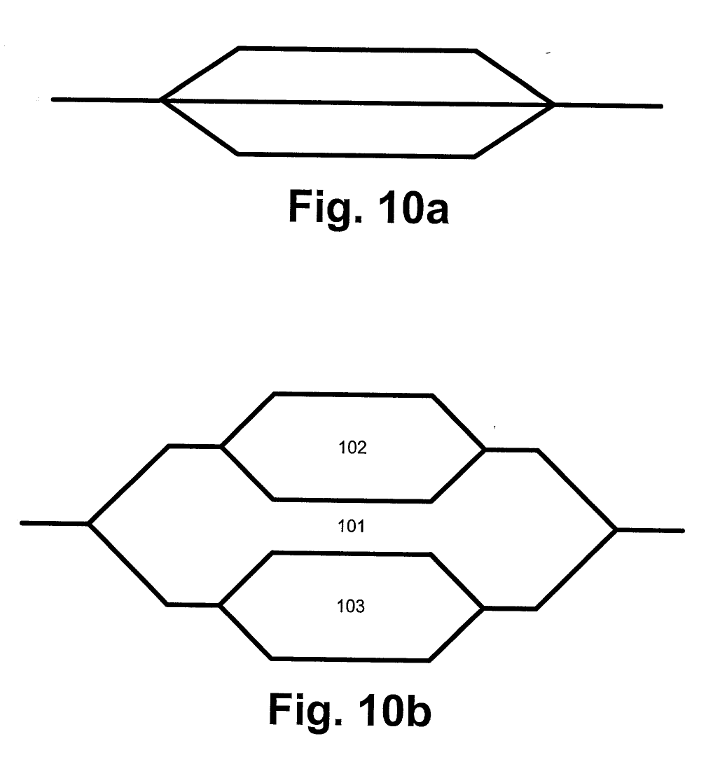

The channel width Wa of the arms is large and close to the second order transverse optical mode cutoff value Wcutoff of the waveguide in the surface of the substrate. In addition, the present invention can be implemented in a variety of MZI's. For example, the present invention can be used in a MZI having more than two arms. As shown in FIG. 10a, appropriate splitters would have to be used to accommodate the additional arms. Furthermore, the present invention can be used in a compound MZI 101 including a plurality of inner MZI'S 102 and 103, as shown in FIG. 10b. For example, the invention can be applied to one of the two inside MZI's 102 and 103, both of the two inside MZI's 102 and 103, just the outside MZI 101, all of the MZI's or portions of each of the MZI's.

The waveguide structures in FIGS. 9a, 9b and 9c are disclosed as being symmetrical end-to-end. However, it is to be understood that any combinations of the above-disclosed embodiments can be used in a MZI. For example, the first splitter could enlarge from a smaller channel width in the input portion to a larger channel width in the arms on the input side of the device and a tapered output portion can be used on the output side of the device.

It will be apparent to those skilled in the art that various modifications and variations can be made in the Mach-Zehnder Interferometer of the present invention without departing from the spirit or scope of the invention. Thus, it is intended that the present invention cover the modifications and variations of this invention provided they come within the scope of the appended claims and their equivalents.

What is claimed is:

1. A waveguide for an optical device comprising:
an input portion for receiving an optical signal and having a first channel width;
a first splitter for separating the optical signal into at least first and second paths;
a first arm for the first path and having a second channel width that prevents a second order transverse optical mode in the first arm;
a second arm for the second path and having a third channel width that prevents a second order transverse optical mode in the second arm;
a second splitter portion for combining optical signals of the at least first and second paths;
an output portion for transmitting a resultant combination of optical signals from the second splitter and having a fourth channel width; and
wherein the second channel width is larger than the fourth channel width.

2. The waveguide of claim 1, wherein the second channel width and the third channel width are substantially equivalent; and
the first channel width and the fourth channel width are substantially equivalent.

3. The waveguide of claim 2, wherein the second splitter comprises:
a first end connected to the first arm and having the second channel width;
a second end connected to the second arm and having the third channel width; and
a third end connected to the output portion and having the fourth channel width.

4. The waveguide of claim 3, wherein the first splitter comprises:
a first end connected to the first arm and having the second channel width;
a second end connected to the second arm and having the third channel width; and
a third end connected to the input portion and having the first channel width.

5. The waveguide of claim 1, wherein the input portion has a first channel length;
the first arm has a second channel length;
the second arm has a third channel length;
the output portion has a fourth channel length; and
wherein the fourth channel length is shorter than the first channel length.

6. The waveguide of claim 1, wherein the waveguide further comprises:
a tapered output section having linear sides positioned between the second splitter and the output portion; and
wherein an end of the tapered output section connected to the second splitter has a channel width that is greater than a channel width of another end of the tapered output section connected to the output portion.

7. The waveguide of claim 6, wherein the waveguide further comprises:
a tapered input section having linear sides positioned between the first splitter and the input portion; and
wherein an end of the tapered input section connected to the first splitter has a channel width that is greater than a channel width of another end of the tapered input section connected to the input portion.

8. The waveguide of claim 1, wherein the output portion has a length of about 3 to 8 millimeters measured from the second splitter to an end of the output portion where an optical fiber can be connected.

9. A waveguide for an optical device comprising:
an input portion for receiving an optical signal and having a first channel width;
a first splitter for separating the optical signal into at least first and second paths;
a first arm for the first path and having a second channel width;
a second arm for the second path and having a third channel width;
a second splitter portion for combining optical signals of the at least first and second paths;
a tapered output section having linear sides positioned between the second splitter and the output portion;
an output portion for transmitting a resultant combination of optical signals from the second splitter and having a fourth channel width; and
wherein the second channel width is larger than the fourth channel width.

10. The waveguide of claim 9, wherein the second channel width and the third channel width are substantially equivalent; and
the first channel width and the fourth channel width are substantially equivalent.

11. The waveguide of claim 9, wherein the waveguide further comprises a tapered input section having linear sides positioned between the first splitter and the input portion.

12. The waveguide of claim 9, wherein an end of the tapered output section connected to the second splitter has a channel width that is greater than a channel width of another end of the tapered output section connected to the output portion.

13. The waveguide of claim 9, wherein the waveguide further comprises a tapered input section having linear sides positioned between the first splitter and the input portion.

14. The waveguide of claim 9, wherein each of the first and second arms only support a single transverse optical mode.

15. A waveguide for an optical device comprising:
an input for receiving an optical signal and having a first channel width;
a first splitter for separating the optical signal into at least first and second paths;
a first arm for the first path and having a second channel width;
a second arm for the second path and having a third channel width;
a second splitter portion for combining optical signals of the at least first and second paths;
a tapered output portion having linear sides for transmitting a resultant combination of optical signals from the second splitter and having a fourth channel width; and
wherein the second channel width is larger than the fourth channel width.

16. The waveguide of claim 15, wherein the second channel width and the third channel width are substantially equivalent; and
the first channel width and the fourth channel width are substantially equivalent.

17. The waveguide of claim 15, wherein the input is a tapered input portion having linear sides.

18. The waveguide of claim 15, wherein the input is comprised of an input portion having a constant channel width.

19. The waveguide of claim 18, wherein the input further comprises a tapered input section having linear sides positioned between the first splitter and the input portion.

20. The waveguide of claim 15, wherein each of the first and second arms only support a single transverse optical mode.

21. A waveguide for an optical device comprising:
an input for receiving an optical signal and having a first channel width;
a first splitter for separating the optical signal into at least first and second paths;
a first arm for the first path and having a second channel width;
a second arm for the second path and having a third channel width;
a second splitter portion for combining optical signals of the at least first and second paths;
an output for transmitting a resultant combination of optical signals from the second splitter and having a fourth channel width; and
wherein the second channel width is larger than the fourth channel width and the output has a length of about 3 to 8 millimeters measured from the second splitter to an end of the output portion where an optical fiber can be connected.

22. The waveguide of claim 21, wherein the output is a tapered output portion having linear sides.

23. The waveguide of claim 21, wherein the output is comprised of an output portion having a constant channel width.

24. The waveguide of claim 23, wherein the output further comprises a tapered output section having linear sides positioned between the second splitter and the output portion.

25. The waveguide of claim 21, wherein each of the first and second arms only support a single transverse optical mode.

26. A method of increasing the extinction ratio in an optical device comprising:
providing an input portion for receiving an optical signal and having a first channel width;
providing a first splitter for separating the optical signal into at least first and second paths;
providing a first arm for the first path and having a second channel width that prevents a second order transverse optical mode in the first arm;
providing a second arm for the second path and having a third channel width that prevents a second order transverse optical mode in the second arm;
providing a second splitter portion for combining optical signals of the at least first and second paths;
providing an output portion for transmitting a resultant combination of optical signals from the second splitter and having a fourth channel width; and
wherein the second channel width is larger than the fourth channel width.

27. A method of increasing the length of an interaction region of an optical device comprising:
providing an input for receiving an optical signal and having a first channel width;
providing a first splitter for separating the optical signal into at least first and second paths;
providing a first arm for the first path and having a second channel width;
providing a second arm for the second path and having a third channel width;
providing a second splitter portion for combining optical signals of the at least first and second paths;
providing an output for transmitting a resultant combination of optical signals from the second splitter and having a fourth channel width; and
wherein the second channel width is larger than the fourth channel width and the output has a length of about 3 to 8 millimeters measured from the second splitter to an end of the output portion where an optical fiber can be connected.
